(19) United States
(12) Patent Application Publication
(10) Pub. No.: US 2005/0083814 A1
(43) Pub. Date: Apr. 21, 2005

(54) Information recording and reproducing apparatus, information recording method and information recording program

(75) Inventors: Masayoshi Yoshida, Saitama (JP); Takeshi Koda, Saitama (JP); Keiji Katata, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/965,021

(22) Filed: Oct. 15, 2004

(30) Foreign Application Priority Data
Oct. 21, 2003 (JP) 2003-360800

(51) Int. Cl. G11B 5/09

(52) U.S. Cl. 369/53.15; 369/53.14

(57) ABSTRACT

As information recording medium, an optical disc, such as a BD-R and the like, is applicable. The optical disc has a recording structure including a lead-in area, a lead-out area and a user data area. In addition, the optical disc is adopted to a defect management system, and a spare area and a defect management area are provided between the user data area and the lead-out area. When recording capacity of the space area becomes insufficient, the spare area is expanded. At the same time, the defect management area is also expanded. Thus, it is possible to cope with the increase of the defect management information due to the increase of the spare area.

### BACKGROUND OF THE INVENTION

1. Field of the Invention

The present invention relates to an information recording apparatus, an information recording method and an information recording program which record information on an information recording medium capable of suitable defect management of recorded information.

2. Description of Related Art

There are known an information recording medium, such as an optical disc, e.g., a DVD-RW (DVD-Re-recordable), a DVD-RAM and a BD-RE (Blu-ray Disc Rewritable), and an information recording and reproducing apparatus capable of recording information on the information recording medium and reproducing the recorded information. So far, a technique of “defect management system” is utilized so as to improve reliance of recording and reading out data on and from a high-density recording medium, such as the optical disc (particularly, a rewritable-type optical disc).

According to the technique, when a flaw, dust or deterioration of the recording medium (which are generally called “defect”) exists on the recording medium, the data recorded or to be recorded at a position at which the defect exists is recorded in another area (hereafter, it is called “spare area”) on the information recording medium. Address information indicating the position of the defect existing on the information recording medium, address information indicating a position (e.g., a recording position) in the spare area to which the data recorded or to be recorded at the position of the defect is moved, and the like are recorded in a “defect management area”.

Like this, if the recording data which may become unrecordable or unreadable by the defect is moved to the spare area, the reliability of recording and reading out of the recording data can be improved.

By the way, not only in rewritable-type media, but also in additionally-recordable-type recording media (i.e., “write-once media”) capable of recording data only once, the defect management technique can be utilized. As the additionally-recordable-type recording media, a DVD-R (DVD-Recordable), a BD-R (Blu-ray Disc Recordable) and the like are known. Generally, though a size of the spare area of the additionally-recordable-type media may be identical to a size of the rewritable-type media, a size of the defect management area of the additionally-recordable-type media, in which defect management information is stored, has to be larger than the size of the defect management area of the rewritable-type media. This is because overwriting at an identical position is impossible in the additionally-recordable-type media, so the management information has to be always additionally recorded in an unrecorded area, while repeated overwriting of the management information at an identical position is possible in the rewritable-type media.

On the other hand, when a function, such as Logical Overwrite and the like, is realized to the additionally-recordable-type media by applying a function of the defect management system, since the data may be moved to the spare area even in the normal writing, a much larger spare area is necessary than in a case of utilizing only the defect management information. Then, it may happen that the spare area becomes insufficient because all recording capacity of the spare area provided on the disc is consumed. Or, since moving the data to the spare area seldom happens irrespective of maintaining the large area by expanding the spare area in advance, the recording capacity of a user data area is consumed in the first place, and the user data area may sometimes become insufficient.

In order to solve the above-mentioned problem, there is proposed a method of expanding or reducing the spare area provided on the disc (see Japanese Patent Application Laid-open under No. 2000-149449). In addition, at the time of expanding the spare area, the defect management area sometimes becomes insufficient. This is because the defect management area in which the defect management information is recorded is also necessary when the increase of the spare area causes the increase of the defect management information.

### SUMMARY OF THE INVENTION

The present invention has been achieved in order to solve the above problems. It is an object of this invention to provide an information recording medium, an information recording and reproducing apparatus, an information recording method and an information recording program capable of performing suitable defect management when expanding or reducing a spare area on the information recording medium, particularly on an additionally-recordable-type recording medium capable of recording information only once.

According to one aspect of the present invention, there is provided an information recording apparatus which records information on an additionally-recordable-type information recording medium including a data area for recording data, a spare area for recording the data to be recorded at a position at which a defect in the data area exists, and a defect management area for recording defect management information of the data area, the information recording apparatus including: an area setting unit which sets respective initial sizes of the spare area and the defect management area; and an area changing unit which expands the spare area and the defect management area with respect to the respective initial sizes.

As an example of the above-mentioned information recording medium, an additionally-recordable-type optical disc, such as a BD-R and the like, is applicable. The information recording medium includes a data area (hereafter, it is also called “user data area”) in which recording data is recorded, such as image data, sound data, contents data, a computer program and the like. A technique of a defect management system is applied to the information recording medium for improving reliability of recording and reading out of the recording data on a high-density recording medium, such as the optical disc and the like. According to the technique, when a flaw, dust or deterioration of the recording medium (i.e., “defect”) exists on the information recording medium, the data recorded or to be recorded at the position at which the defect exists is recorded in another area (i.e., “spare area”) on the information recording medium. Address information indicating the position of the defect existing on the information recording medium, and address information indicating a position (e.g., a recording position) in the spare area to which the data recorded or to be recorded at the position of the defect is moved are recorded in the defect management area.

The above-mentioned information recording apparatus can record the information, such as the image data, the contents and the like, on the BD-R which is the additionally-recordable-type optical disc, and can reproduce the information recorded on the recording medium. The information recording apparatus can set the initial spare area and the initial defect management area to the information recording medium. Since overwriting at an identical position is impossible in the additionally-recordable-type optical disc and management information has to be always additionally recorded in an unrecorded area, the spare area and the defect management area have to be set large. When the spare area and the defect management area which are initially set become insufficient, the information recording apparatus can expand the sizes thereof with respect to the initial sizes. Thereby, since the defect management area is expanded at the same time as the expansion of the spare area, it is possible to cope with the increase of the information to be managed due to the expansion of the spare area.

The area changing unit may set an expanded spare area and an expanded defect management area in the data area to expand the spare area and the defect management area. As described above, when the spare area which is initially set becomes insufficient, the spare area can be expanded by setting a new spare area within a portion of the user data area. Further, by newly setting the defect management area within a portion of the user data area at the same time as the expansion of the new spare area, the defect management area can be also expanded. Thereby, it is possible to cope with the increase of the information to be managed due to the expansion of the spare area.

The area changing unit may expand the spare area and the defect management area by a unit of an expanding set including the expanded spare area and the expanded defect management area. The information recording and reproducing apparatus does not necessarily expand the spare area of an optional size at one time. Namely, the information recording and reproducing apparatus may expand the spare area by allocating plural sets each having predetermined size (including the spare area and the defect management area of predetermined size, positioned next to each other, and which are called “expanding sets”). The expanding set may be set one by one when the expansion is necessary, or the plural expanding sets may be set together in advance.

The area changing unit may set the expanding sets in order in a direction opposite to a direction of recording the data from an ending position of the data area. For example, the area changing unit sets the expanded area from an outer side of the information recording medium, such as the optical disc, and records the recording data from inside of the data area to outside. Thereby, since the expanded area is not erased by the recording data, effective recording of the data is possible.

The area changing unit may include an obtaining unit which obtains the respective sizes of the expanded spare area and the expanded defect management area from outside. The information recording apparatus may obtain a ratio of the sizes of the spare area and the defect management area in the above-mentioned expanding set, or the size of the expanding set itself from outside. The user may set the sizes.

The area changing unit may reduce the expanded spare area and the defect management area by the unit of the expanding set. When the user data area becomes insufficient, the reduction of the spare area and the defect management area is necessary (i.e., it is necessary to release an unused area set as the expanding set from inside and allocate it to the user data area). In such a case, the information recording apparatus can reduce the areas by the unit of the expanding set in order from the position of an inner side of the last expanded area (or, the last reduced area). The reduced areas are allocated to the user data area. In a case of the unused expanding set, the information recording apparatus can reduce the expanded areas by releasing any number of unused expanding sets at one time. As described above, if the spare area and the defect management area are expanded by the unit of the expanding set, effective reduction can be executed. Thereby, unnecessarily large recording capacity of the defect management area never remains after the reduction of the spare area.

According to another aspect of the present invention, there is provided an information recording method which records information on an additionally-recordable-type information recording medium including a data area for recording data, a spare area for recording the data to be recorded at a position at which a defect in the data area exists, and a defect management area for recording defect management information of the data area, the information recording method including: a setting process which sets respective initial sizes of the spare area and the defect management area; and an area changing process which expands the spare area and the defect management area with respect to the respective initial sizes. By the information recording method, the spare area can also be controlled, identically to the above-mentioned information recording apparatus.

According to still another aspect of the present invention, there is provided a computer program product in a computer-readable medium executed by an information recording apparatus to record information on an additionally-recordable-type information recording medium including a data area for recording data, a spare area for recording the data to be recorded at a position at which a defect in the data area exists, and a defect management area for recording defect management information of the data area, the computer program product including: a setting unit which sets respective initial sizes of the spare area and the defect management area; and an area changing unit which expands the spare area and the defect management area with respect to the respective initial sizes. By the computer program product in the computer-readable medium executed by the information recording apparatus, the spare area can also be performed, identically to the above-mentioned information recording apparatus.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A and 1B are diagrams showing a recording structure of an information recording medium according to a first embodiment of the present invention.

FIG. 2 is a diagram showing a recording structure of a defect management area according to the first embodiment.

FIGS. 3A and 3B are diagrams showing a recording structure of an information recording medium according to a second embodiment of the present invention.

FIG. 4 is a diagram explaining a problem with reduction of a spare area.

FIGS. 5A to 5D are diagrams showing a recording structure of an information recording medium according to a third embodiment of the present invention.

FIG. 6 is a block diagram of an information recording and reproducing apparatus, which is an embodiment of the present invention.

FIG. 7 is a block diagram showing a disc drive of the information recording and reproducing apparatus shown in FIG. 6.

FIG. 8 is a block diagram showing a back end of the information recording and reproducing apparatus shown in FIG. 6.

FIG. 9 is a flow chart showing a procedure of setting a size of a spare area according to the present invention.

FIG. 10 is a flow chart showing a process of setting the size of the spare area, which is performed during a process in FIG. 9.

### DETAILED DESCRIPTION OF THE PREFERRED EMBODIMENTS

The preferred embodiments of the present invention will now be described below with reference to the attached drawings.

[Information Recording Medium]

### 1st Embodiment

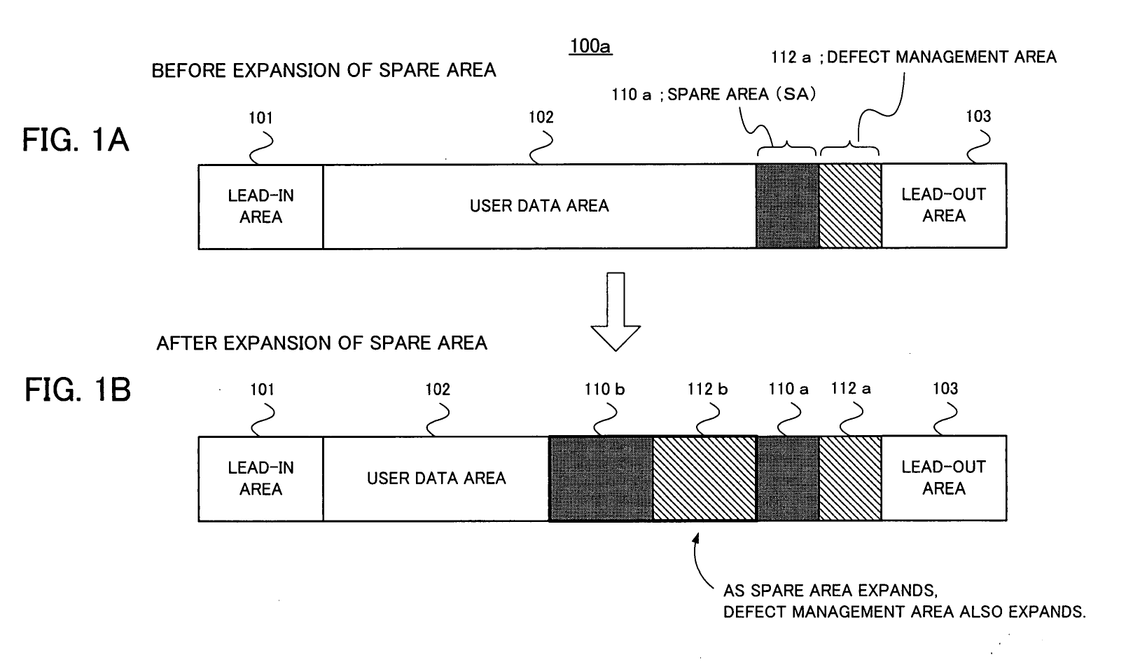

First, the description will be given of a method of recording information on an information recording medium according to a first embodiment of the present invention. FIGS. 1A and 1B show a recording structure of an optical disc 100a, which is the information recording medium according to the first embodiment, recorded information and the like. It is noted that a left side indicates an inner side of the optical disc 100a, and a right side indicates an outer side of the optical disc 100a in FIGS. 1A and 1B. An explanation will be given by assuming the BD-R, which is the additionally-recordable-type recording medium capable of recording data only once, as the optical disc 100a, below.

As shown in FIG. 1A, as a basic configuration, the optical disc 100a has the recording structure that a lead-in area 101 exists inside, a user data area 102 exists outside the lead-in area 101, and a lead-out area 103 exists outside the user data area 102.

In the lead-in area 101 and the lead-out area 103, control information for controlling and managing of recording and reading out information or data of the optical disc 100a and the like are recorded.

On the other hand, in the user data area 102, data mainly subjected to reproducing or executing, such as image data, sound data, contents data and computer program, and the like are recorded.

Further, a spare area (SA) 110a and a defect management area 112a are set in this order from inside of the optical disc 100a between the user data area 102 and the lead-out area 103.

The defect management area 112a is used for a defect management system during recording the data on the additionally-recordable-type media. The defect management system is a technique which is performed for improving reliability of recording and reading out of the recording data on a high-density recording medium, such as the optical disc, a magnetic disc, a magneto-optical disc and the like. Namely, when a flaw, dust or deterioration of the recording medium exists on the recording medium, the data recorded or to be recorded at the position at which the defect exists is recorded in the spare area 110a on the optical disc 100a. Like this, if the recording data which may become unrecordable or unreadable by the defect is moved to the spare area 110a, the reliability of recording and reading out of the recording data can be improved.

It is noted that the user can preset sizes (i.e., storage capacity) of the spare area 110a and the defect management area 112a in FIG. 1A, which will be explained in detail later. In addition, positions at which the spare area 110a and the defect management area 112a are disposed are not limited to the positions shown in FIG. 1A. For example, the spare area 110a and the defect management area 112a may be disposed between the lead-in area 101 and the user data area 102, inside the lead-in area 101 or inside the lead-out area 103.

By the way, as described above, when the spare area 110a becomes insufficient (e.g., when all the spare area 110a is used), the problem can be solved by expanding the spare area 110a. Then, since defect management information increases due to the increase of the spare area 110a, the defect management area 112a also becomes insufficient. Therefore, the present invention adopts a method of expanding the defect management area 112a at the same time with expanding the spare area 110a, unlike a method of expanding only the spare area 110a.

FIG. 1B concretely shows a method of expanding the spare area 110a and the defect management area 112a according to the first embodiment. As shown in FIG. 1B, when the spare area 110a which the user initially sets becomes insufficient, a portion of the user data area 102 is reserved in the first place. When the whole reserved area is an unrecorded area, the spare area 110a can be expanded by setting a spare area 110b in the reserved area. Namely, it is possible to reserve an area immediately after the user data recorded at the outermost position in the user data area 102 for expanding the spare area and the defect management area. Moreover, in the present embodiment, the defect management area 112a is also expanded by newly setting a defect management area 112b in the reserved area, at the same time that the spare area 110b is expanded. Thereby, it is possible to cope with the increase of information to be managed, due to the expansion of the spare area 110.

It is noted that, in the first embodiment, the area inside the spare area 110a and the defect management area 112a which are initially set is reserved, and further the spare area 110b and the defect management area 112b are disposed in this order from inside in the reserved area. At the time of the expansion, the user can also set the sizes of the spare area 110b and the defect management area 112b which are used for the expansion.

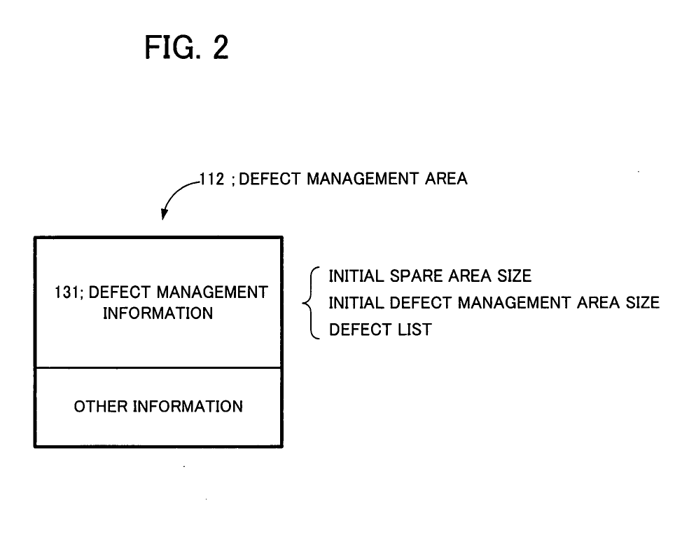

In addition, defect management information 131 is recorded in the defect management area 112, as shown in FIG. 2. An initial spare area size, an initial defect management area size, a defect list and the like are recorded as the defect management information 131. As the initial spare area size (i.e., the size of the spare area 110a) and the initial defect management area size (i.e., the size of the defect management area 112a), the information which the user sets, for specifying the size, is recorded. The user can also set the sizes of the spare area 110b and the defect management area 112b which are used at the time of the expansion, and the information for specifying the sizes can be recorded as the defect management information 131. Alternatively, by determining a ratio of the sizes of the spare areas 110b and the defect management area 112b to a predetermined value, only the information for specifying the size of the spare area 110b may be recorded in the defect management information 131.

On the other hand, address information indicating the position of the defect existing on the optical disc 100a, and address information indicating a position (e.g., the recording position) in the spare area to which the data recorded or to be recorded at the position of the defect is moved are recorded in the defect list.

### 2nd Embodiment

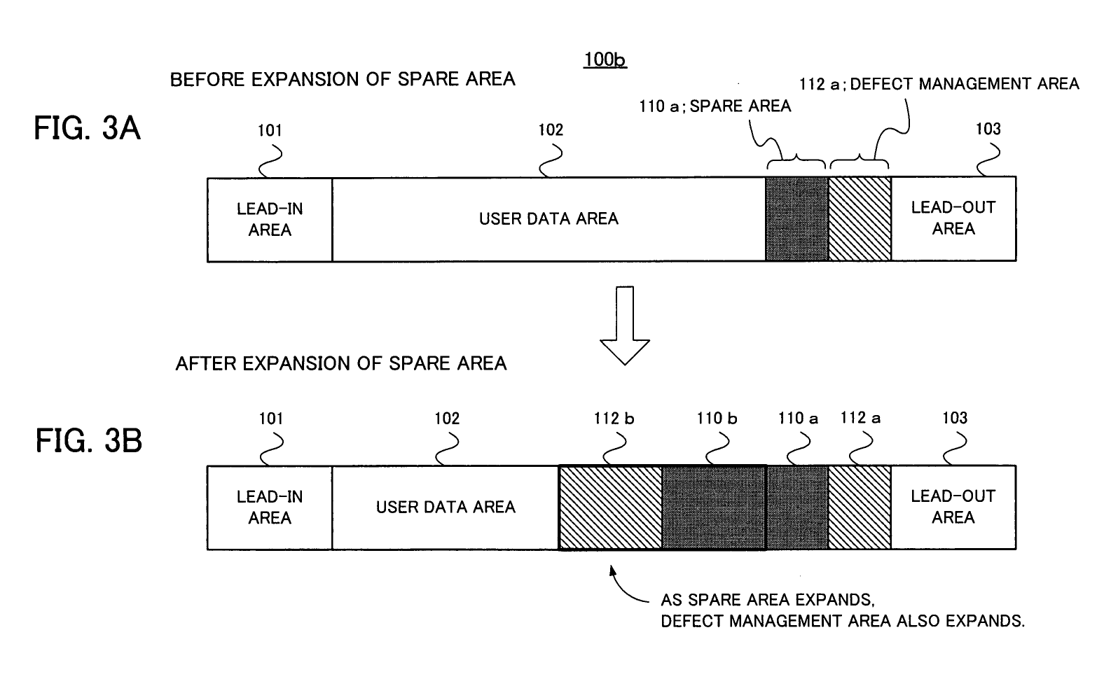

Next, the description will be given of a method of expanding the spare area 110a and the defect management area 112a according to a second embodiment. FIGS. 3A and 3B show a recording structure of an optical disc 100b, which is the information recording medium according to the second embodiment, and recorded information.

In FIGS. 3A and 3B, the left side indicates an inner side of the optical disc 100b, and the right side indicates an outer side of the optical disc 100b, too. FIG. 3A is identical to FIG. 1A, and the optical disc 100b has the recording structure that the lead-in area 101, the user data area 102 and the lead-out area 103 are formed in this order from inside. Identically to the first embodiment, the spare area 110a and the defect management area 112a are formed between the user data area 102 and the lead-out area 103.

Also in the second embodiment, the defect management area 112a is expanded at the same time that the spare area 110a is expanded. However, in the second embodiment, the disposition of the spare area 110b and the defect management area 112b which are used at the time of the expansion is different from the disposition of those shown in the first embodiment.

FIG. 3B concretely shows the method of expanding the spare area 110a and the defect management area 112a according to the second embodiment. When the initial spare area 110a becomes insufficient, a portion of the user data area 102 is reserved in the first place. When the whole reserved area is an unrecorded area, the spare area can be expanded by newly setting the spare area 110b. It is possible to reserve the area immediately after the user data recorded at the outermost position in the user data area 102 for expanding the spare area and the defect management area. In the second embodiment, the defect management area 112a is expanded by setting the new defect management area 112b in the above-mentioned reserved area, at the same time that the spare area 110b is expanded. It is noted that the area inside the spare area 110a and the defect management area 112a which are initially disposed is reserved as the reserved area.

In the second embodiment, the defect management area 112b and the spare area 110b are set in this order from inside in the reserved area. Namely, the second embodiment is different from the first embodiment in that the order of the spare area 100b and the defect management area 112b used at the time of the expansion are opposite.

As explained above, since the defect management area 112 is expanded at the same time, it is possible to cope with the increase of the information to be managed due to the expansion of the spare area 110.

### 3rd Embodiment

Now, the description will be given of a method of expanding the spare area 110 and the defect management area 112 according to a third embodiment. Also in the third embodiment, the defect management area 112 is expanded at the same time that the spare area 110 is expanded.

First, the description will be given of a problem which may occur at the time of reducing the size of the spare area 110 on the optical discs 100a and 100b on which expanding the spare area according to the first and second embodiments is performed. The reduction of the size is performed, when recording capacity actually used as the spare area is smaller than the size of the expanded area although the spare area 110 and the defect management area 112 are expanded, and when it is preferred to reduce the expanded area and allocate the reduced area to the user data area 102. Namely, when the recording capacity of the user data area 102 becomes insufficient, the user data area is expanded by reducing the unused expanded area.

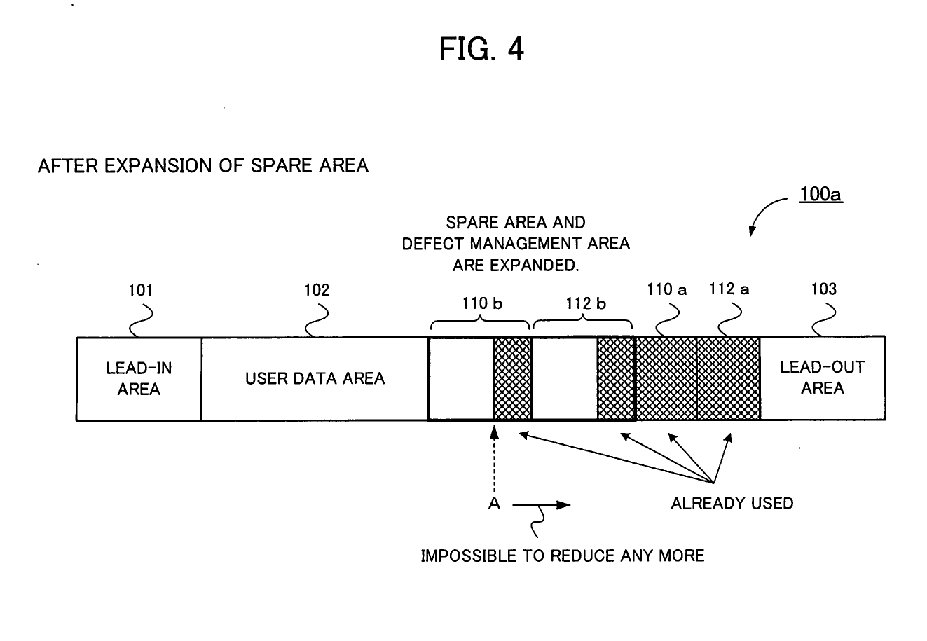

FIG. 4 shows an example of reducing the spare area 110 on the optical disc 100a on which the expansion of the spare area 110 according to the first embodiment is performed. Since all the spare area 110a and the defect management area 112a which are initially set on the optical disc 100a are used, a new spare area 110b and a new defect management area 112b are provided. It is assumed that areas actually used in the spare area 110b and the defect management area 112b are reticulated portions shown in FIG. 4. When the unused area is reduced to create the user data area 102, the spare area 110b can be reduced only to a position indicated by “A” because the data is recorded outside the position A in the expanded spare area 110b. Therefore, since the unused area in the defect management area 112b cannot be reduced, the unnecessarily large unused area remains.

In the third embodiment, the spare area 110 and the defect management area 112 are expanded in order to solve the above-mentioned problem. Concretely, the information recording and reproducing apparatus does not expand the spare area of an optional size at one time, as shown in the first and second embodiments. Namely, the information recording and reproducing apparatus expands the spare area by disposing plural sets having predetermined sizes (each including a spare area 110b of a predetermined size and a defect management area 112b of a predetermined size, disposed next to each other, and which is called “expanding set”). The disposing the expanding set may be performed one by one when the expansion is necessary, and alternatively the plural expanding sets may be disposed together in advance. The expanding set is disposed next to an inner side of the last disposed expanding set.

On the other hand, when the spare area 110 and the defect management area 112 are reduced, an unused expanding set already disposed on the disc is eliminated in the order from the inner side of the optical disc (i.e., the area of the unused expanding set is newly allocated to the user data area 102). Thereby, there is no problem that the unnecessarily large unused area of the defect management area 112b remains, when the spare area 110b is reduced, as described above. Advantageously, since the size of the expanding set is fixed, even if the plural expanding sets are disposed, managing information about the positions and the sizes of the respective expanding sets is unnecessary, and managing only the number of the expanding sets disposed on the disc is necessary.

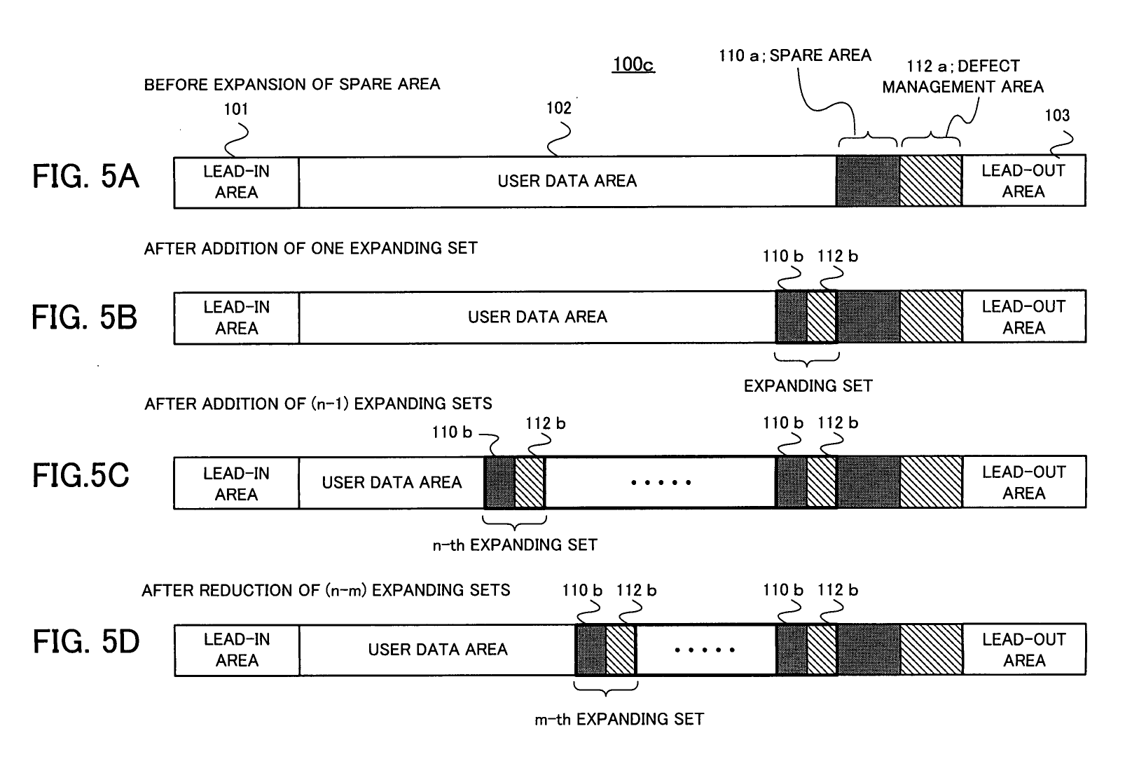

FIGS. 5A to 5D schematically show a method of expanding and a method of reducing the spare area and the defect management area according to the third embodiment. As shown in FIG. 5A, the optical disc 100c has the recording structure that the lead-in area 101, the user data area 102 and the lead-out area 103 are formed in this order from inside. Identically to the above-mentioned embodiments, the spare area 110a and the defect management area 112a are disposed between the user data area 102 and the lead-out area 103.

Next, FIG. 5B will be explained. When the spare area 110a becomes insufficient, a portion of the user data area 102 is reserved from outside in the first place. Here, the size of the reserved area is equal to the size of one expanding set or the sum of the plural expanding sets to be disposed. When the whole reserved area is the unrecorded area, the expanding set is disposed in the area. Namely, it is possible to reserve the area immediately after the user data recorded at the outermost position in the user data area 102 for disposing the expanding set.

The ratio of the sizes of the spare area 110b and the defect management area 112b in the above-mentioned expanding set may be set by the user or set to the predetermined size. In addition, the size of the expanding set itself may be set by the user or set to the predetermined size.

As described above, when the spare area 110b initially provided becomes insufficient, one or plural expanding set(s) may be disposed again by the identical method as the need arises.

Like this, since the expanding set is disposed from an outer side of the user data area 102, if the user data is recorded in order from an inner side in the user data area 102, the user data can be most efficiently recorded, and the expansion of the spare area becomes easy.

On the other hand, when the user data area 102 becomes insufficient, as shown in FIG. 5C, the reduction of the spare area 110b and the defect management area 112b is necessary (i.e., it is necessary to release the unused area disposed as the expanding set from the inner side and allocate the area to the user data area 102). In such the case, the reduction is performed by a method shown in FIG. 5D. Namely, the reduction is performed in order from an edge portion inside the last expanded area (occasionally, the last reduced area) by the unit of the above-mentioned expanding set. The reduced area is allocated to the user data area 102. If the expanding sets are unused, the reduction is possible releasing any number of expanding sets at one time. FIG. 5D shows an example that (n−m) expanding sets are reduced after the expansion of n expanding sets (n>m).

As described above, if the spare area 110b and the defect management area 112b are expanded by the unit of the expanding set, the reduction can be effectively performed. Namely, as shown in FIG. 4, by the reduction of the spare area 110b, it can be prevented that the unnecessarily large unused recording capacity of the defect management area 112b remains.

As shown in FIG. 2, the defect management information 131 and the like are recorded in the defect management area 112. The initial spare area size, the initial defect management area size, the defect list and the like are recorded in the defect management information 131. As the initial spare area size (i.e., the size of the spare area 110a) and the initial defect management area size (i.e., the size of the defect management area 112a), the sizes which the user sets are recorded. In addition, the user can also set the sizes of the spare area 110b and the defect management area 112b at the time of the expansion, and the sizes can be recorded in the defect management information 131. Or, by defining the ratio of the sizes of the spare area 110b and the defect management area 112b in the expanding set to a predetermined value, storing the information on the disc may be omitted. Further, in the defect management information 131, a number of areas (i.e., the number of the expanding sets) of the expanded spare area, such as “n” and “m” shown in FIGS. 5A to 5D can also be recorded.

On the other hand, address information indicating the position of the defect existing on the optical disc 100c, and address information indicating the position of the spare area to which the data recorded or to be recorded at the position of the defect is moved (e.g., the recording position in the spare area) are recorded in the defect list. All the above-mentioned newest information can be recorded in the defect list in the defect management area 112b expanded latest. In addition, only difference between the newest information and the information recorded in the defect management area 112b expanded at the last time can also be recorded in the respective defect lists in the plural defect management areas 112b.

[Information Recording and Reproducing Apparatus]

The information recording and reproducing apparatus according to the present invention will now be described.

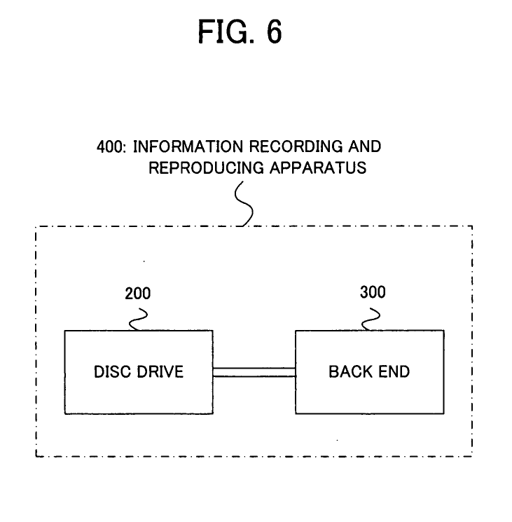

First, a configuration of an information recording and reproducing apparatus 400 will be explained. FIG. 6 shows the information recording and reproducing apparatus 400 which is the embodiment of the present invention. The information recording and reproducing apparatus 400 has two functions: a function of recording information on the recording medium, and a function of reproducing the recorded information which is recorded on the recording medium. Concretely, the information recording and reproducing apparatus 400 can reproduce information from a disc for recording and reproducing, such as the BD-R and the like, and can record the information on the disc for recording and reproducing. In addition, the information recording and reproducing apparatus 400 can also reproduce a disc dedicated to reproducing, such as a BD-ROM and the like. The information recording and reproducing apparatus 400 includes a disc drive 200 and a back end 300.

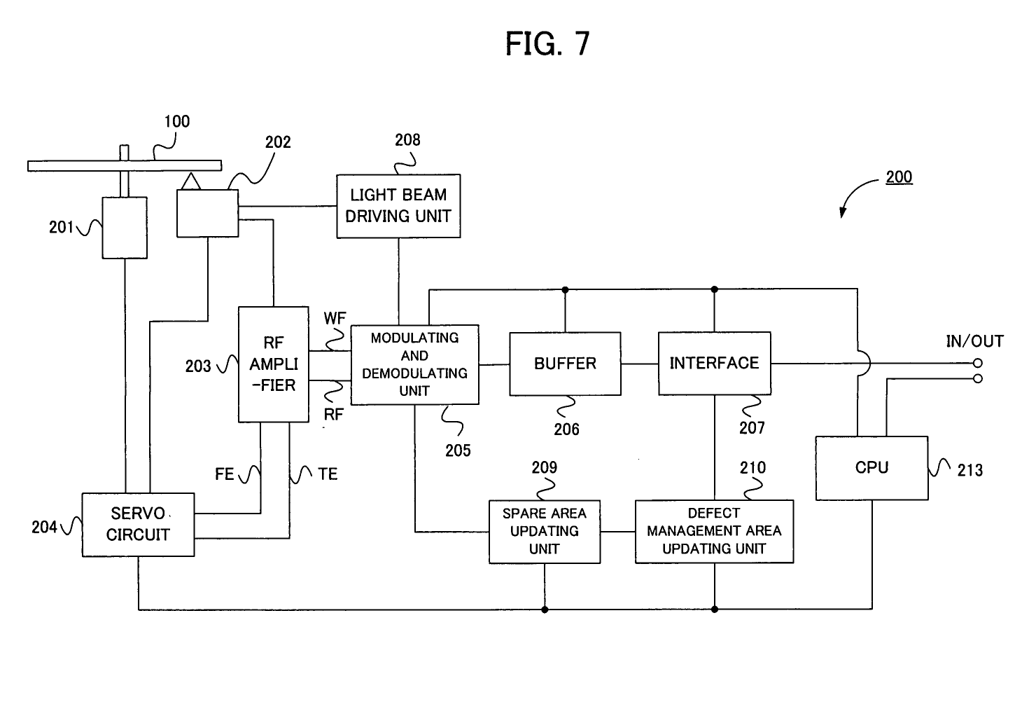

FIG. 7 shows an inside configuration of the disc drive 200. The disc drive 200 records the information on the optical disc 100, and reads out the information which is recorded on the optical disc 100. The optical disc 100 is one of the above-mentioned disc for recording and reproducing or the above-mentioned disc dedicated to reproducing.

As shown in FIG. 7, the disc drive 200 includes a spindle motor 201, an optical pickup 202, an RF amplifier 203 and a servo circuit 204. They mainly configure a driving system of the disc drive 200 and a driving control unit thereof.

The spindle motor 201 rotates the optical disc 100.

The optical pickup 202 outputs an RF signal corresponding to a reflected light of a light beam at the time of recording and reading out the information.

The RF amplifier 203 amplifies the RF signal outputted from the optical pickup 202, and outputs the RF signal to a modulating and demodulating unit 205. Further, the RF amplifier 203 generates a wobble frequency signal WF, a tracking error signal TE, a focus error signal FE and the like from the RF signal, and outputs them.

The servo circuit 204 is a servo control circuit which controls the driving of the optical pickup 202 and the spindle motor 201 on the basis of the tracking error signal TE, the focus error signal FE and the other servo control signal. Concretely, the servo circuit 204 controls a positional relation between the optical pickup 202 and a track on the optical disc 100 on the basis of the tracking error signal TE. The servo circuit 204 controls focusing of the light beam from the optical pickup 202 on the basis of the focus error signal FE.

Moreover, as shown in FIG. 7, the disc drive 200 includes the modulating and demodulating unit 205, a buffer 206, an interface 207 and a light beam driving unit 208. Those components mainly demodulate and output the recorded information which is read out from the optical disc 100, and receive and modulate the recording information to be recorded on the optical disc 100.

The modulating and demodulating unit 205 is a circuit which has two functions: a function of performing error correction of the recording information at the time of reading out the information, and a function of adding an error correction code to the recording information at the time of recording the information and modulating it. Concretely, at the time of reading out the information, the modulating and demodulating unit 205 demodulates the RF signal outputted from the RF amplifier 203, and performs the error correction to it to output it to the buffer 206. In addition, at the time of recording the information, the modulating and demodulating unit 205 adds the error correction code to the recording information outputted from the buffer 206, and modulates it so as to be adapted to the optical characteristic of the optical disc 100. Afterward, the modulating and demodulating unit 205 outputs the modulated recording information to the light beam driving unit 208.

The buffer 206 is a storing circuit which stores the recording information.

The interface 207 is a circuit which performs input and output control or communication control of the recording information between the disc drive 200 and the back end 300. Concretely, at the time of reproducing the information, the interface 207 outputs, to the back end 300, the recording information outputted from the buffer 206 (i.e., the recording information which is read out from the optical disc 100), in response to a request command from the back end 300. In addition, at the time of recording the information, the interface 207 receives the recording information inputted from the back end 300 to the disc drive 200, and outputs it to the buffer 206.

Further, the disc drive 200 includes a spare area updating unit 209 and a defect management area updating unit 210.

The spare area updating unit 209 records, in the spare area 110a and the like, the data recorded or to be recorded at the position at which the defect exists, when the defect exists on the optical disc 100. In addition, when the recording capacity of the spare area 110a becomes insufficient, for example, the spare area updating unit 209 expands the spare area 110 by disposing the spare area 110b at a new position by the above-mentioned method in response to a request command from the user or a host computer. Conversely, when the recording capacity of the user data area 102 becomes insufficient, the spare area updating unit 209 reduces the spare area 110 by allocating the spare area 110b to the user data area 102 by the above-mentioned method in response to the request command from the user or the host computer. It is noted that the spare area updating unit 209 executes the processes by an instruction from a CPU 213.

On the other hand, in recording the data in the spare area 110, the defect management area updating unit 210 updates the defect management information 131 recorded in the defect management area 112a, information of a number of an expanded spare area and the like. As the defect management information 131, the initial spare area size, the initial defect management area size, the defect list and the like are recorded, as described above. In addition, the information related to the expanded spare area, such as the number of the expanded spare area, is recorded in the lead-in area 101, for example. Further, the defect management area updating unit 210 expands the defect management area 112a by the above-mentioned method, at the same time as the expansion of the spare area 110a. Moreover, the defect management area updating unit 210 reduces the defect management area 112b by allocating the defect management area 112b to the user data area 102 by the above-mentioned method. The defect management area updating unit 210 executes the processes by the instruction from the CPU 213.

The CPU 213 can control the whole disc drive 200, and can control and manage the above-mentioned transmission of the information among respective components in the disc drive 200. For example, in the present invention, the CPU 213 executes the process on the basis of the sizes of the initial spare area 110a and the initial defect management area 112a, the sizes of the spare area 110b and the defect management area 112b to be expanded or reduced, and an instruction of expanding or reducing the spare area 110a, or an instruction of neither expanding nor reducing the spare area 110a, which are obtained from the user. Concretely, on the basis of the instruction obtained from the user, the CPU 213 reserves the user data area, and controls the spare area updating unit 209 and the defect management area updating unit 210 to update the information recorded in the spare area 110 and the defect management area 112. Also, the CPU 213 executes the process of expanding or reducing the spare area 110 and the defect management area 112, as described above.

Further, the CPU 213 can control a reading operation of the optical pickup 202, and can control output of the recorded information stored in the buffer 206 to the back end 300 to control a normal reproduction and a first-reading of contents information, in response to the request command transmitted from the back end 300 which will be described later.

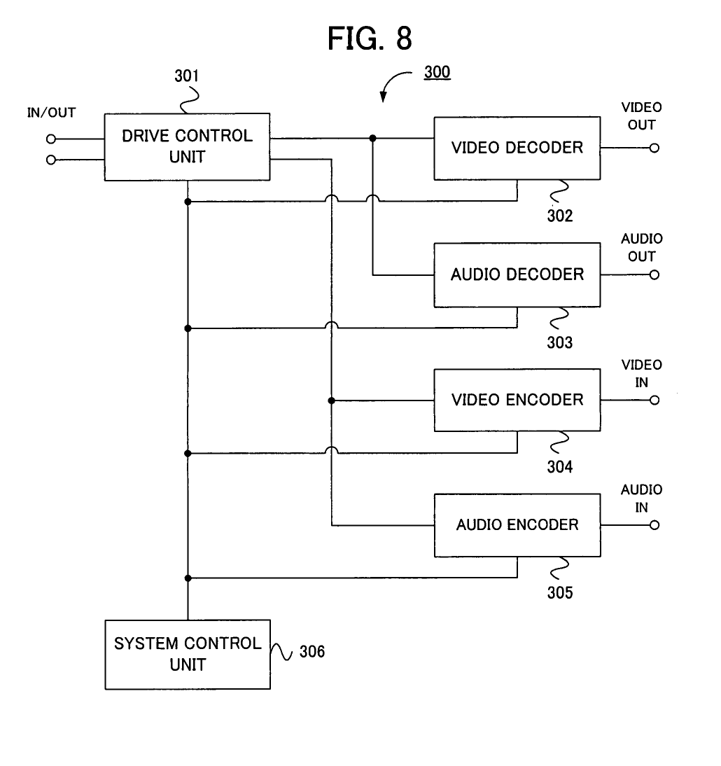

Next, the description will be given of an inside configuration of the back end 300 shown in FIG. 8. The back end 300 performs a reproducing process of the recording information which is read out from the optical disc 100 by the disc drive 200. Also, the back end 300 receives the recording information which is supplied from outside in order to be recorded on the optical disc 100, and compresses (encodes) and transmits it to the disc drive 200.

As shown in FIG. 8, the back end 300 includes the drive control unit 301, a video decoder 302, an audio decoder 303, a video encoder 304, an audio encoder 305 and a system control unit 306.

The drive control unit 301 is a circuit which controls a reading process and a recording process of the disc drive 200. The back end 300 and the disc drive 200 perform, in cooperation with each other, an operation of reading out the recording information from the optical disc 100 to reproduce it, and an operation of receiving the information to be recorded from outside to record it on the optical disc 100. The drive control unit 301 realizes the cooperation between the back end 300 and the disc drive 200 by controlling the reading process and the recording process of the disc drive 200. Concretely, the drive control unit 301 outputs, to the disc drive 200, the request command about reproduction, recording and outputting of the recording information from the buffer 206. Further, in the present embodiment, the drive control unit 301 can also perform the input and output control for controlling input or output of the spare area updating unit 209 and the defect management area updating unit 210, identically to the above-mentioned CPU 213.

The video decoder 302 and the audio decoder 303 demodulate recording data, which is read out from the optical disc 100 by the disc drive 200 and is supplied via the drive control unit 301, to convert it in a reproducible state by a display, a speaker and the like.

The video encoder 304 and the audio encoder 305 are circuits which receive a picture signal and a sound signal, inputted from outside in order to be recorded on the optical disc 100, and which encode the signals by an MPEG encoding system to supply them to the disc drive 200 via the drive control unit 301, respectively.

The system control unit 306 is a circuit which controls the drive control unit 301, the video decoder 302 and the audio decoder 303 and which executes the reproducing process of the recorded data in cooperation with those units, at the time of the reproduction. At the time of the recording, the system control unit 306 controls the drive control unit 301, the video encoder 304 and the audio encoder 305, and executes the recording process of the recording data in cooperation with those units. In addition, at the time of the reproduction and the recording, the system control unit 306 executes control of the disc drive 200 (e.g., generation and transmission of various request commands, receiving a response signal and the like), together with the drive control unit 301, in order to realize the cooperation with the disc drive 200 and the back end 300.

[Process of Setting Size of Spare Area]

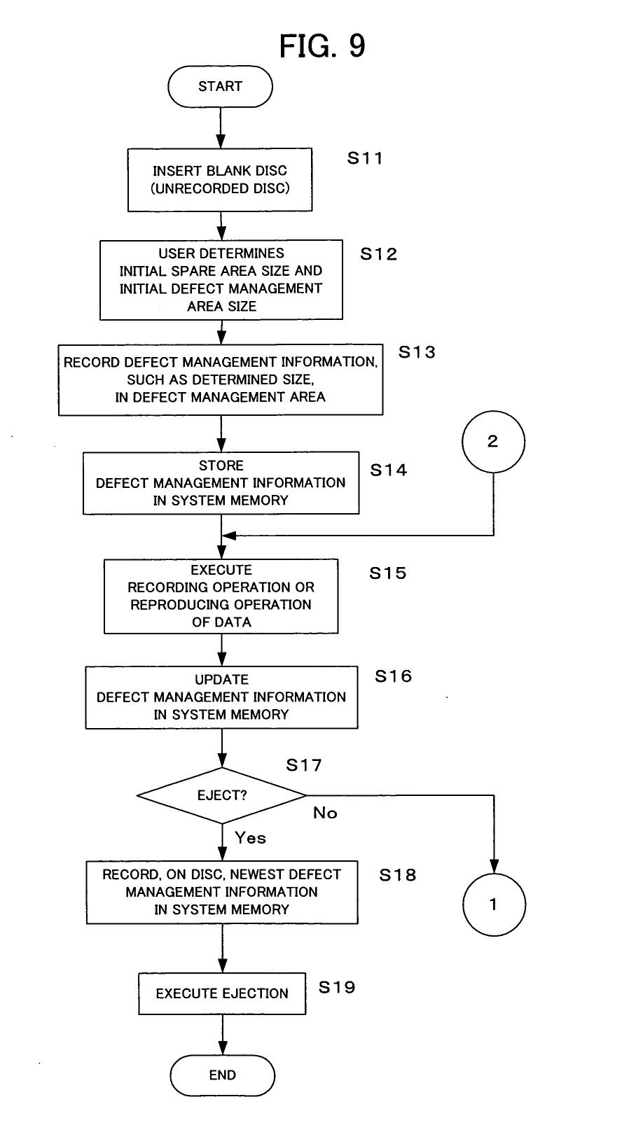

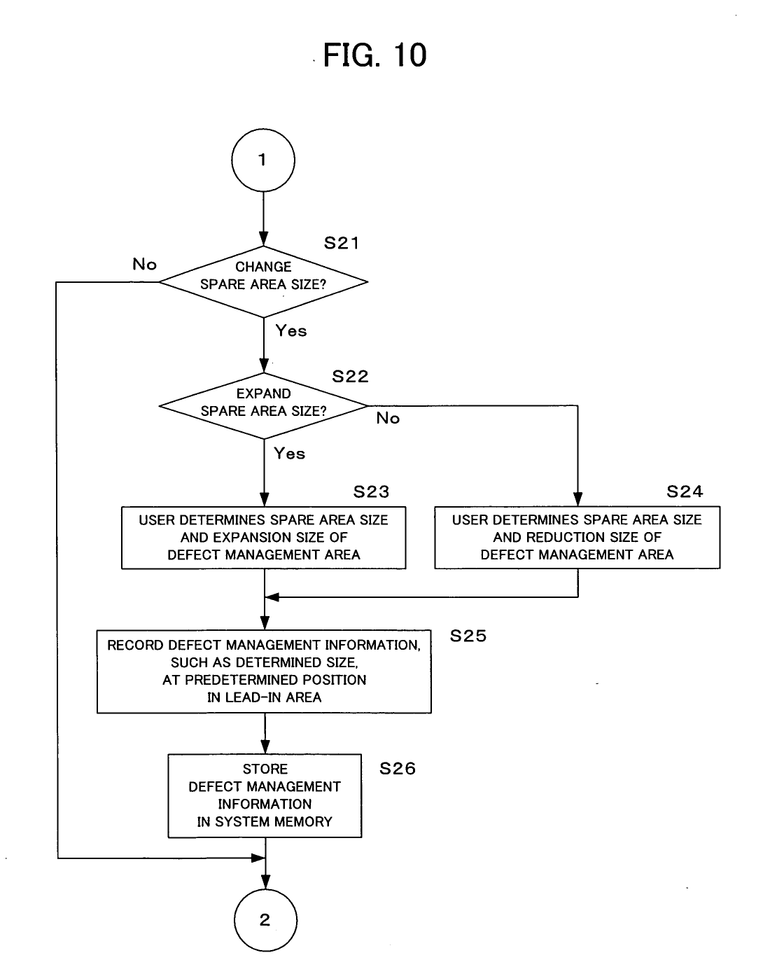

Next, the description will be given of a process of setting the size of the spare area according to the present invention, which the above-mentioned information recording and reproducing apparatus 400 executes. FIG. 9 and FIG. 10 show flow charts showing procedures thereof. As for the process which will be explained below, primarily, the CPU 213 expands or reduces the spare area 110 and the defect management area 112 on the basis of setting instructions from the user or an application in the host computer (not shown), and further updates the defect management information 131.

First, in step S11 shown in FIG. 9, the user inserts a blank disc (an unrecorded disc), such as the BD-R and the like, in the information recording and reproducing apparatus 400. The process goes to step S12.

In step S12, the user determines the sizes of the initial spare area 110a and the initial defect management area 112a, and the CPU 213 obtains information thereof. Then, the process goes to step S13.

In step S13, the CPU 213 records the above-mentioned initial sizes and the like, which the user determines, in the defect management area 112a on the optical disc 100 as the defect management information 131. The process goes to step S14.

In step S14, the CPU 213 stores the above-mentioned defect management information 131 in a system memory (not shown) in the CPU 213. Then, the process goes to step S15.

In step S15, the CPU 213 makes the information recording and reproducing apparatus 400 execute a reproducing operation of the data to be reproduced and the recording operation of the data to be recorded on the optical disc 100. When the recording operation or the reproducing operation ends, the process goes to step S16.

In step S16, the CPU 213 updates the defect management information 131 in the system memory to the newest data. When the spare area 110 and the defect management area 112 are expanded or reduced in the process shown in FIG. 10 which will be described later, the information recorded in the system memory in step S14 becomes different from the information recorded in the defect management information 131. When the above-mentioned process ends, the process goes to step S17.

In step S17, the CPU 213 determines whether the user issues a command “eject” of the optical disc 100 or not. In the present embodiment, the CPU 213 records, on the optical disc 100, the defect management information 131 recorded in the system memory in the CPU 213, at the time of ejecting the optical disc 100. When the command “eject” is issued (step S17; Yes), the process goes to step S18. However, when the command “eject” is not issued (step S17; No), the process of the flow chart shown in FIG. 10 is executed.

In step S18, since the user has issued the command “eject”, the CPU 213 records, on the optical disc 100, the newest defect management information 131 recorded in the system memory. Thereby, the newest information is recorded in the defect management area 112 on the optical disc 100. When the above-mentioned process ends, the process goes to step S19, and the CPU 213 executes an ejecting operation of the optical disc.

On the other hand, in step S17, when the user does not issue the command “eject”, the process shown in FIG. 10 is executed. The process of the flow chart shown in FIG. 10 is executed mainly for expanding or reducing the spare area 110.

First, in step S21, the user issues a command whether the user wants to change the size of the spare area 110 or not (i.e., a command whether the user wants to expand or reduce the size of the spare area 110 or not), and the CPU 213 obtains the command. The CPU 213 executes determination on the basis of the command. In the present embodiment, the information recording and reproducing apparatus 400 does not change the size of the spare area 110 by automatic determination. Therefore, after obtaining the command from the user or the application in the host computer (not shown), the CPU 213 executes the change. When the command of changing the size is issued (step S21; Yes), the process goes to step S22. However, when the command of changing the size is not issued (step S21; No), the process returns to step S15 shown in FIG. 9, and the process is repeated.

In step S22, the user issues a command whether the user wants to expand the spare area 110 or not, and the CPU 213 obtains the command. The CPU 213 executes the determination on the basis of the command. When the command of expanding the size is issued (step S22; Yes), the process goes to step S23. However, when the command of expanding the size is not issued (step S22; No), the process goes to step S24.

In step S23, the user further determines not only the size of the spare area 110b, which is used at the time of the expansion, but also the size of the defect management area 112b. This is because the defect management area 112 is expanded at the same time that the spare area 110 is expanded, as described above, in the present invention. When the methods of the expansion according to the first and second embodiments described before are used, the setting of a larger size is preferred. On the other hand, when the method of the expansion according to the third embodiment is used, the setting of a comparatively smaller size is preferred. The CPU 213 obtains the expanded size thus determined. When the above-mentioned process ends, the process goes to step S25.

In step S24, when the command of the expansion is not issued in step S22, which means that the command of reducing the spare area 110 is issued, the process of reproducing the spare area 110 is executed. In step S24, the user determines not only the size of the spare area 110b at the time of the reduction, but also the size of the defect management area 112b. This is because the defect management area 112 is reduced at the same time that the spare area 110 is reduced, as described above, in the present invention (particularly, in a case of using the method of the reduction according to the third embodiment). The CPU 213 obtains the reduced size thus determined. Then, the process goes to step S25.

In step S25, the CPU 213 records the expanded or reduced sizes of the spare area 110 and the defect management area 112, which the user determines, at a predetermined position in the lead-in area 101 on the optical disc 100. Then, the process goes to step S26.

In step S26, the CPU 213 stores the above-mentioned defect management information 131 in the system memory (not shown) in the CPU 213. When the above-mentioned process ends, the process returns to step S15 shown in FIG. 9 again, and the process is repeated. When the optical disc 100 is ejected, the CPU 213 can record, on the optical disc 100, the newest defect management information 131 stored in the system memory in the CPU 213.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-360800 filed on Oct. 21, 2003 including the specification, claims, drawings and summary is incorporated herein by reference in its entirety.

1. An information recording apparatus which records information on an additionally-recordable-type information recording medium, the information recording medium comprising a data area for recording data, a spare area for recording the data to be recorded at a position at which a defect in the data area exists, and a defect management area for recording defect management information of the data area, the information recording apparatus comprising:
an area setting unit which sets respective initial sizes of the spare area and the defect management area; and
an area changing unit which expands the spare area and the defect management area with respect to the respective initial sizes.

2. The information recording apparatus according to claim 1, wherein the area changing unit sets an expanded spare area and an expanded defect management area in the data area to expand the spare area and the defect management area.

3. The information recording apparatus according to claim 2, wherein the area changing unit expands the spare area and the defect management area by a unit of an expanding set comprising the expanded spare area and the expanded defect management area.

4. The information recording apparatus according to claim 3, wherein the area changing unit sets the expanding sets in order in a direction opposite to a direction of recording the data from an ending position of the data area.

5. The information recording apparatus according to claim 3, wherein the area changing unit comprises an obtaining unit which obtains the respective sizes of the expanded spare area and the expanded defect management area from outside.

6. The information recording apparatus according to claim 3, wherein the area changing unit reduces the expanded spare area and the defect management area by the unit of the expanding set.

7. An information recording method which records information on an additionally-recordable-type information recording medium comprising a data area for recording data, a spare area for recording the data to be recorded at a position at which a defect in the data area exists, and a defect management area for recording defect management information of the data area, the information recording method comprising:
a setting process which sets respective initial sizes of the spare area and the defect management area; and
an area changing process which expands the spare area and the defect management area with respect to the respective initial sizes.

8. A computer program product in a computer-readable medium executed by an information recording apparatus to record information on an additionally-recordable-type information recording medium comprising a data area for recording data, a spare area for recording the data to be recorded at a position at which a defect in the data area exists, and a defect management area for recording defect management information of the data area, the computer program product comprising:
a setting unit which sets respective initial sizes of the spare area and the defect management area; and
an area changing unit which expands the spare area and the defect management area with respect to the respective initial sizes.
